(19) United States
(12) Patent Application Publication
(10) Pub. No.: US 2011/0203059 A1
(43) Pub. Date: Aug. 25, 2011

(54) LOADING DOCK LIGHTING SYSTEMS HAVING WARNING FEATURES

(75) Inventors: L. Blake Whitley, Arlington, TX (US); Richard K. Hoofard, Dallas, TX (US)

(73) Assignee: 4Front Engineered Solutions, Inc., Carrollton, TX (US)

(21) Appl. No.: 13/030,970

(22) Filed: Feb. 18, 2011

Related U.S. Application Data
(60) Provisional application No. 61/306,867, filed on Feb. 22, 2010.

(51) Int. Cl. B65G 69/34; E01D 1/00; H01K 7/00

(52) U.S. Cl. 14/71.3; 315/76

(57) ABSTRACT

Loading dock lighting systems having one or more colored lights for communicating information, such as loading dock equipment status information, to dock operators and/or other personnel working in or around a shipping trailer or other transport vehicle are disclosed herein. In one embodiment, for example, a lighting system for illuminating the interior of a transport vehicle during loading/unloading can include a lighting feature that visually communicates information to a person or persons working in the vehicle. The lighting feature can include, for example, one or more lights of various colors and/or flashing lights.

### CROSS-REFERENCE TO RELATED APPLICATION(S)

The present application claims priority under 35 U.S.C. §119(e) to U.S. Provisional Application No. 61/306,867, filed Feb. 22, 2010, and entitled “LOADING DOCK LIGHTING SYSTEMS HAVING WARNING FEATURES,” which is incorporated herein in its entirety by reference.

### PATENT(S) AND/OR APPLICATION(S) INCORPORATED BY REFERENCE

The disclosure of U.S. Pat. No. 7,274,300 is incorporated herein in its entirety by reference.

### TECHNICAL FIELD

The following disclosure is directed generally to lighting systems for use with loading docks.

### BACKGROUND

Conventional loading docks typically include an elevated door (e.g., an overhead door) on a side of a warehouse or other building. To load or unload a trailer or other transport vehicle, the doors on the back of the vehicle are opened and the vehicle is backed up to the loading dock door. A vehicle restraint (e.g., a barrier, hook, wheel chocks, etc.) is typically employed to hold the vehicle in position in front of the loading dock door. The loading dock door can then be raised or otherwise opened and a dock leveler extended between the floor of the warehouse and the open end of the transport vehicle. Conventional dock levelers typically include a deck that rotates upwardly and away from the floor, and then downwardly as a lip on the front edge of the deck rotates outwardly. As the deck descends, the lip comes to rest on the bed of the transport vehicle. Once the dock leveler has been properly positioned, forklifts, workers, etc. can move back and forth over the dock leveler to load and/or unload the vehicle.

Conventional loading docks typically include lights for illuminating the interior of transport vehicles during loading and unloading operations. A typical dock light includes an incandescent light or light-emitting diode (LED) to provide white or near white light that is projected into the open end of a trailer or truck. The dock light is typically mounted to one side of the loading dock opening on an extensible arm that allows it to be moved into a desired position for use and out of the way when not in use. The light can be manually turned on with a conventional switch, or automatically turned on by means of an inter-connect that is operably coupled to another piece of dock equipment, such as a loading dock door, vehicle restraint, or dock leveler.

A typical shipping trailer can be up to 60 feet in length. In addition, the ambient noise level in a typical warehouse environment can be very high. These factors can make it difficult to inform or warn a person working deep in a trailer that the status of a piece of dock equipment may have changed. For example, it may be difficult to communicate to a person moving cargo at the forward end of a trailer that the vehicle restraint has inadvertently disengaged. Accordingly, it would be advantageous to provide a system for communicating information, such as dock equipment status information, to persons working in shipping vehicles at loading docks.

### BRIEF DESCRIPTION OF THE DRAWINGS

FIG. 1 is an isometric view of a loading dock having a lighting system configured in accordance with an embodiment of the disclosure for communicating information.

FIG. 2 illustrates a group of control panels for operating loading dock equipment.

FIG. 3A is a rear view of the lighting system of FIG. 1, and FIG. 3B is an enlarged isometric front view of the lighting system of FIG. 1.

FIG. 4 is a partially schematic view of a lighting system and associated control circuitry configured in accordance with an embodiment of the disclosure.

### DETAILED DESCRIPTION

The present disclosure describes various embodiments of loading dock lighting systems that can include one or more features for communicating information, such as equipment status information to dock operators and/or other personnel. In one embodiment, for example, a lighting system for illuminating the interior of a transport vehicle during loading/unloading can include a lighting feature that visually communicates information to a person or persons working in the vehicle. The lighting feature can include, for example, various colors of light and/or flashing lights. Activation of the lighting feature can provide a visual signal to a person or persons working inside the vehicle that, for example, the status of a piece of dock equipment, such as a vehicle restraint, has changed.

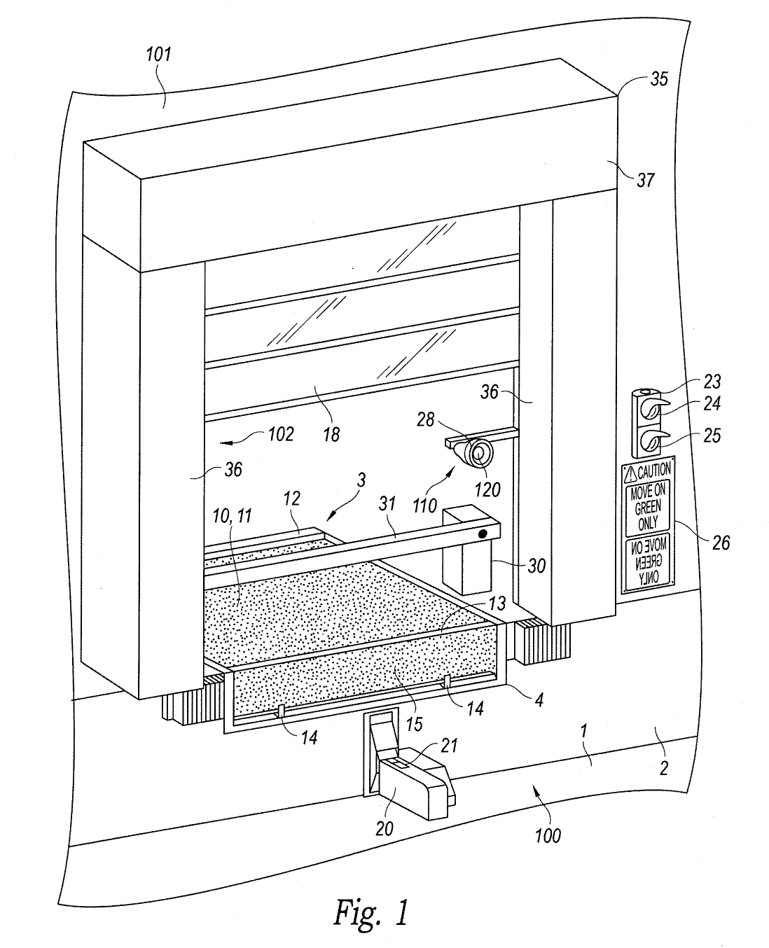

Certain details are set forth in the following description and in FIGS. 1-4 to provide a thorough understanding of various embodiments of the disclosure. Other details describing well-known structures and systems often associated with loading docks, loading dock equipment, lighting systems, programmable logic controllers, etc. have not been set forth in the following disclosure to avoid unnecessarily obscuring the description of the various embodiments of the disclosure.

Many of the details, dimensions, angles and other features shown in the Figures are merely illustrative of particular embodiments of the disclosure. Accordingly, other embodiments can add other details, dimensions, angles and features without departing from the spirit or scope of the present invention. In addition, those of ordinary skill in the art will appreciate that further embodiments of the invention can be practiced without several of the details described below.

FIG. 1 is an isometric view of a loading dock 100 having a lighting system 110 configured in accordance with an embodiment of the disclosure. In the illustrated embodiment, the loading dock 100 includes a driveway 1 positioned adjacent to an opening or doorway 102 in a warehouse or other building 101. The opening 102 can include a door 18 (e.g., a powered roll-up or overhead door), which is shown partially open in FIG. 1, and a barrier gate 30. The barrier gate 30 can include a barrier arm 31 that rotates from a horizontal position where it prevents access to the opening 102, to a vertical position where it allows access to the opening 102. A vehicle restraint 20 (e.g., an electric vehicle restraint) is mounted to or near a dock face 2 and includes a movable hook or barrier 21. The barrier 21 can move vertically to engage the rear impact guard (“RIG”) of a truck or tractor trailer (not shown) to secure the shipping vehicle at the loading dock 100 and prevent, for example, inadvertent “early departure” and/or “trailer creep” away from the dock face 2.

The loading dock 100 can further include a dock shelter and/or dock seal 35. In the illustrated embodiment, the dock seal 35 includes compressible side members 36 extending vertically along each side of the opening 102, and a compressible head member 37 extending horizontally across the top of the opening 102. When a truck or trailer backs into the loading dock 100, the aft end of the truck or trailer compresses the side members 36 and the head member 37, and forms an environmental seal between the truck or trailer and the dock wall.

The loading dock 100 can include a dock leveler 10 (e.g., a hydraulic dock leveler) positioned adjacent to the opening 102. The dock leveler 10 includes a movable deck 11 having an aft edge portion pivotally attached to a frame 12. The frame 12 is mounted in a pit 4 formed in a floor 3 of the building 101. A lip 15 is pivotally attached to a forward edge portion of the deck 11 via one or more hinges 13. In the stored position shown, the distal or outer edge portion of the lip 15 is supported by keepers 14 mounted toward the front of the frame 12.

In operation, the deck 11 rotates upwardly and then downwardly as the lip 15 rotates outward and eventually comes to rest on the bed of an open truck, trailer or other shipping vehicle (not shown). The deck 11 and extended lip 15 thereby provide a ramp from the warehouse floor 3 to the truck or trailer, so that one or more persons, a fork lift, etc. can move back and forth over the deck 11 and lip 15 to load and/or unload the trailer.

A signal assembly 23 can be mounted adjacent to the opening 102 for providing signals to the vehicle driver. For example, the signal assembly 23 can include a red light 24 and a green light 25. When the green light 25 is illuminated, the driver can back up to or pull away from the loading dock 100. Conversely, when the red light 24 is illuminated, the driver should not pull away from the loading dock 100. These instructions can be posted on a nearby sign 26. The sign 26 can include reversed lettering so that the driver can read the sign 26 in a truck mirror.

The lighting system 110 can include a dock light 28 movably mounted proximate one side of the opening 102 to illuminate the interior of a trailer during loading and/or unloading operations. In one aspect of this embodiment, the dock light 28 can include one or more signal lights 120. As described in greater detail below, the signal light or lights 120 can be configured to inform and/or warn the dock operator and/or other personnel working in or around the vehicle of a change in status of an associated piece of dock equipment, such as the dock leveler 10, the vehicle restraint 20, etc. Such changes in status can include, for example, partial or total disengagement of the vehicle restraint 20, partial closure of the door 18, partial or total closure of the barrier gate 30, and/or retraction of the lip 15 away from the vehicle bed, etc.

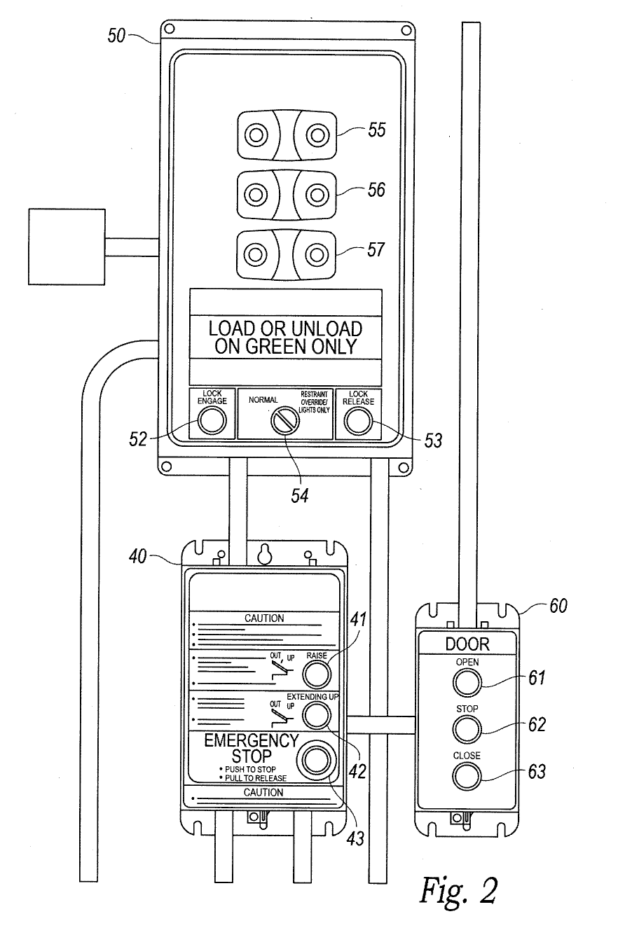

FIG. 2 illustrates a group of control panels that can be positioned inside the loading dock 100 for operating the dock leveler 10, the vehicle restraint 20, and the door 18. For example, a dock leveler control panel 40 can have a first button 41 that raises the dock leveler deck 11, a second button 42 that extends the hinged lip 15, and a third button 43 that is an Emergency Stop which stops all of the dock leveler functions. A vehicle restraint control panel 50 can have a selector switch 54, an engage button 52, and a release button 53. The selector switch 54 can have two positions: Normal, and Restraint Override/Lights Only, which allows the operator to bypass the vehicle restraint if the truck or trailer cannot be captured by the vehicle restraint and must be restrained by wheel chocks. A red light 55, an amber light 56, and a green light 57 can be used to indicate the status of the vehicle restraint 20 to the dock operator. A door control panel 60 can similarly have three buttons: an Open button 61, a Close button 63, and a Stop button 62.

Referring to FIGS. 1 and 2 together, a typical operating sequence of the loading dock equipment described above may be as follows. When the loading dock 100 is not in use, the exterior green light 25 is illuminated to indicate that a truck or trailer may approach or leave the dock. The interior red light 55 is illuminated to indicate that the dock is not in a condition for use. After a trailer backs in to be loaded or unloaded, a dock operator approaches the vehicle restraint control panel 50 and presses the engage button 52. The vehicle restraint barrier 21 rises to engage the truck or trailer rear impact guard. When the barrier 21 starts to rise, the exterior red light 24 is illuminated to indicate that the truck driver cannot leave. Once the rear impact guard has been properly engaged by the barrier 21 so that the truck or trailer is restrained, the interior green light 57 is illuminated to indicate that the loading dock 100 is ready to use. Conversely, if the Vehicle restraint 20 cannot restrain the trailer, then the dock operator must manually chock the truck or trailer wheels. In this situation, the operator may turn the selector switch 54 from Normal to Restraint Override/Lights Only position. Both the interior green light 55 and amber light 56 are now illuminated to indicate that the dock is safe to use, but that the operator should use greater caution because the vehicle restraint 20 has not engaged the truck or trailer.

Once the truck or trailer has been sufficiently restrained by either the vehicle restraint 20 or chocks, the operator can depress the Door Open button 61 on the door control panel 60 to raise the door 18. The operator can then turn to the dock leveler control panel 40 and press the Raise button 41 to raise the deck 11 and extend the lip 15. The operator releases the Raise button 41 to lower the deck 11 onto the truck or trailer bed. Pressing the Lip Extend button 42 can allow faster deck operation by causing the lip 15 to extend before the deck 11 is fully raised. Pressing the Emergency Stop button 43 causes the dock leveler 10 to stop so that it will not descend on top of, for example, any misplaced cargo.

In some embodiments, the dock light 28 can be automatically turned on when the door 18 is raised. In other embodiments, the dock light 28 can include a manual On/Off switch that the operator turns on to illuminate the interior of the truck or trailer for loading and/or unloading. When the loading/unloading operation is finished, the operating sequence can be reversed, or at least generally reversed. For example, the operator can press the dock leveler Raise button 41 to raise the deck 11 and retract the lip 15, and then release the Raise button 41 to lower the deck 11 to the stored position. The operator can also press the Door Close button 63 to lower the door 18, and press the Release button 53 to lower the vehicle restraint barrier 21 and release the trailer. As the barrier 21 starts to lower, the interior red light 55 can be illuminated to indicate that the dock is not ready for use. When the barrier 21 is fully lowered, the exterior green light 25 can be illuminated to indicate that the truck driver may leave.

Although FIG. 2 illustrates a group of separate control panels, in other embodiments, the loading dock 100 can include a combination control panel having controls for a dock leveler, a vehicle restraint, and a powered door. The control buttons and switches can have identical, or at least generally similar functions as the corresponding control buttons and switches described above with reference to the separate panels illustrated in FIG. 2. Various embodiments of the control panels described above can include a suitable Programmable Logic Controller (PLC) to allow many different control sequences and interconnect relationships. As is known, PLCs can receive input signals from various devices, such as limit switches and push buttons, and transmit output signals to various devices and/or equipment, such as lights, relays and motors in accordance with the logic defined by the control program.

The design, manufacture, and use of PLCs and associated electrical circuits, program statements, etc. are well known in the loading dock industry and, accordingly, are not set forth in detail herein to avoid unnecessarily obscuring the description of the various embodiments of the disclosure. Moreover, as those of ordinary skill in the art will appreciate, the various apparatuses, systems, and methods described above with reference to FIGS. 1 and 2 are merely illustrative of various embodiments of loading docks and loading dock equipment that can incorporate and/or employ light warning systems configured in accordance with the present disclosure. Accordingly, the light warning systems and related features described herein are not limited to the particular loading dock configurations illustrated in FIGS. 1 and 2.

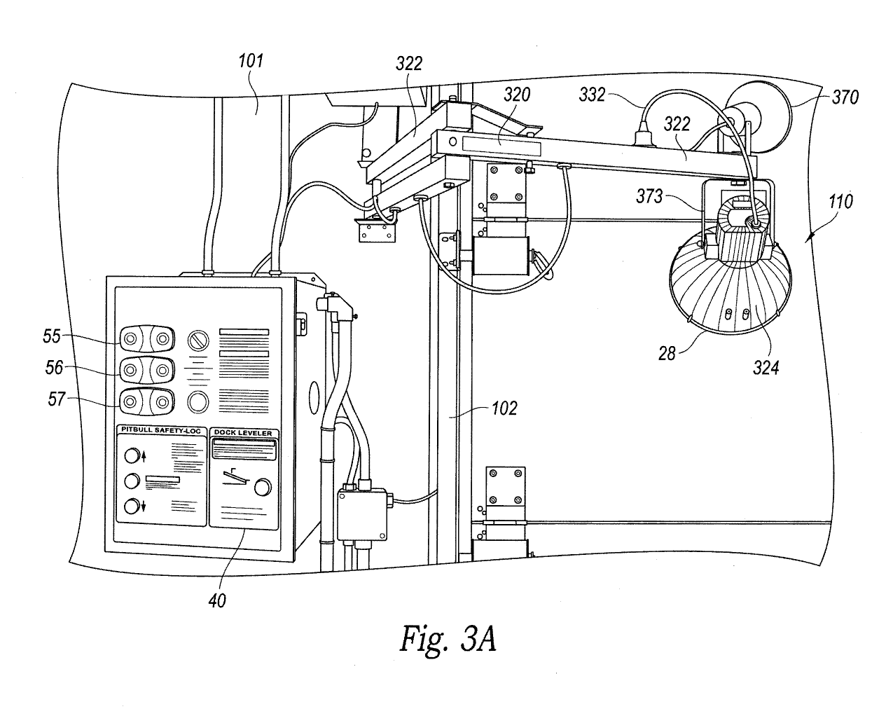

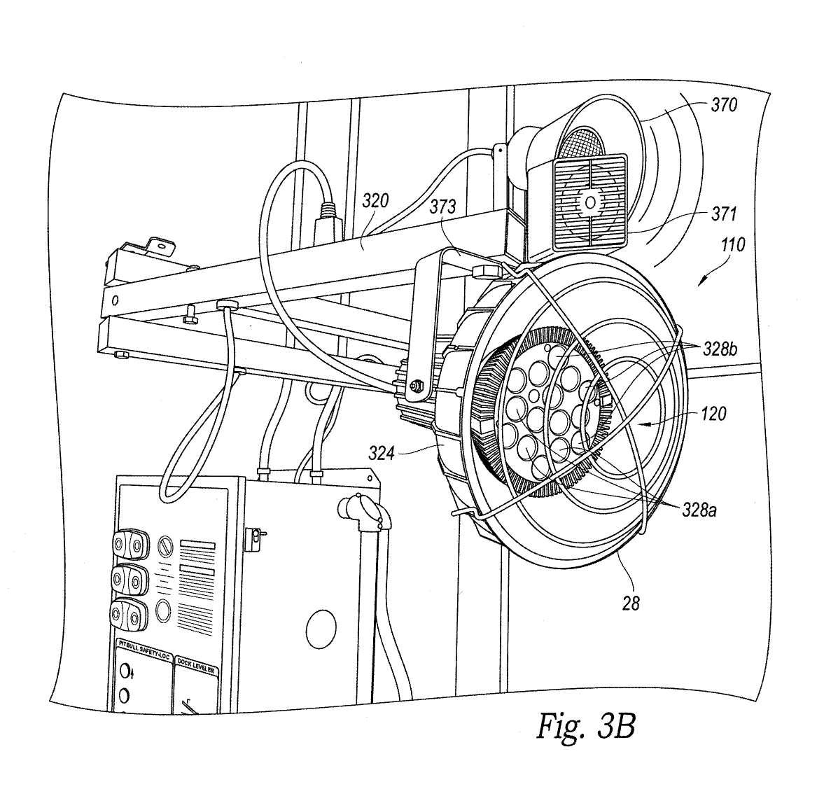

FIG. 3A is a view from inside the building 101 looking outwardly toward the lighting system 110, and FIG. 3B is a related front isometric view of the dock light 28. Referring to FIGS. 3A and 3B together, in the illustrated embodiment the dock light 28 is mounted to a distal end of an articulating arm 320. The articulating arm 320 is pivotally mounted to an inner wall of the building 101 proximate the door opening 102. The articulating arm 320 can include one or more links 322 that allow the dock light 28 to be manually moved into a suitable location for vehicle loading/unloading. In other embodiments, the dock light 28 can be movably supported by other types of mounting apparatuses including, for example, extensible arms, coils, etc.

As shown in FIG. 3B, in the illustrated embodiment the dock light 28 includes a first array of white or near white light-emitting diodes (LEDs) 328a and a second array of colored LEDs 328b that comprise the signal light 120. Under normal operating conditions, the first array of white LEDs 328a can provide white or near white light for illuminating the interior portion of a transport vehicle during loading/unloading. By way of example, in one embodiment such normal operating conditions can include when the vehicle restraint 20 is properly engaged with the shipping vehicle to secure it at the loading dock 100. In another embodiment, such normal operating conditions can include when the vehicle restraint 20 is properly engaged with the shipping vehicle and the dock leveler deck 11 and/or lip 15 is properly extended into the vehicle. In other embodiments, such normal operating conditions can include when the vehicle restraint 20 is properly engaged with the shipping vehicle, the dock leveler deck 11 and/or lip 15 is properly extended into the vehicle, the barrier gate 30 is in the raised position, and/or the door 18 is fully opened. In still further embodiments, such normal operating conditions can include other operational conditions of other types of equipment related to or associated with operation of the loading dock 100.

The colored LEDs 328b can include, for example, an array of red LEDs that illuminate (and/or flash) only when there is a change in status of an associated piece of dock equipment that a dock operator and/or other persons loading/unloading the vehicle may have an interest in. For example, in one embodiment the colored LED array 328b could illuminate when the vehicle restraint 20 changes status from locked to unlocked. In another embodiment, the colored LED array 328b could illuminate or flash when the dock leveler lip 15 changes status from extended to retracted, when the barrier gate 30 changes status from raised to lowered or at least partially lowered, and/or when the door 18 changes status from fully opened to at least partially closed. Both the first and second arrays of LEDs can receive facility power via a suitable power cord 332. The LED arrays can also receive power from other suitable sources, a battery, etc.

In operation, the first array of white LEDs 328a in the dock light 28 would illuminate the interior of the transport vehicle so that it could be loaded and/or unloaded in a conventional manner. In the event that the status of a piece of dock equipment changed, the signal light 120 could be illuminated to warn the dock operator of this occurrence. The immediate change in the ambient light color from white to, for example, red, will alert the dock operator of the change in equipment status.

In other embodiments, other colored light signals can be used (e.g., green, blue, amber, etc.) in place of, or in addition to, the red LEDs 328b. For example, in another embodiment the signal light 120 can include an array of blue LED's (not shown) in addition to the red LEDs 328b. In this embodiment, illumination of the red LEDs 328b could signal a change in status of a first piece of dock equipment (e.g., the vehicle restraint 20), and illumination of the blue LEDs could signal a change in status of another piece of dock equipment (e.g., the dock leveler 10). In yet another embodiment, one or more of the LED arrays associated with the signal light 120 can be pulsed or flashed to attract the attention of the operator. In a further embodiment, the first array of white LEDs 328a can automatically turn off to remove the normal white light so that only the, e.g., red light from second array of colored LEDs 328b is visible in the event of a status change.

Although in the illustrated embodiment the signal light 120 is integrated with and/or otherwise carried within a housing or cover 324 of the dock light 28, in other embodiments the colored signal light or lights can be contained in a secondary housing and/or mounted independently of the dock light 28. In a further embodiment, the colored signal light array can be omitted, and equipment status can be communicated to the dock operator by pulsing or flashing the existing dock light 28. In yet other embodiments, directional strobe lights can be utilized to warn the dock operator or communicate a change in vehicle or equipment status.

In the embodiment described above, the various dock lights and/or signal lights can be LED light sources. In other embodiments, however, virtually any type of visible light source can be used to communicate information to the dock operator and/or individuals working in or around the transport vehicle. For example, in other embodiments all or some of the colored LEDs described above can be replaced with one or more incandescent, florescent, halogen, and/or other suitable light sources having, e.g., suitably colored lenses. Similarly, in other embodiments all or some of the white LEDs described above can be replaced with incandescent, florescent, halogen, and/or other suitable light sources. In some embodiments, it is contemplated that one or more tunable light sources, or an array of tunable light sources (e.g., an array of tunable LEDs) can be used to emit both white or near white light for normal loading/unloading operations, and colored light for signaling a change in equipment status. Moreover, in further embodiments the signal light 120 and associated systems can be retrofitted to an existing loading dock lighting system and/or integrated with existing loading dock equipment.

In yet another embodiment, the loading dock 100 can further include an audio device, such as a speaker 370 or an alarm 371, for providing an audible warning to the dock operator in conjunction with the visual light signals, or even exclusive of the light signals under certain circumstances. Suitable alarms can include, for example, a Model FS 255 alarm from Preco Incorporated of Boise, Id. 83704. The audio device can provide an additional layer of communication by focusing or directing the audible signals so that they are effective at transport vehicle distances, and/or are only audible to those personnel working at the affected dock station. Moreover, the audio device can be mounted to the dock light housing 324, to a dock light mounting bracket 373, or other structure so that the audio device moves in conjunction with the dock light 28 and is directed in the same general direction (e.g., into the shipping vehicle) as the dock light 28.

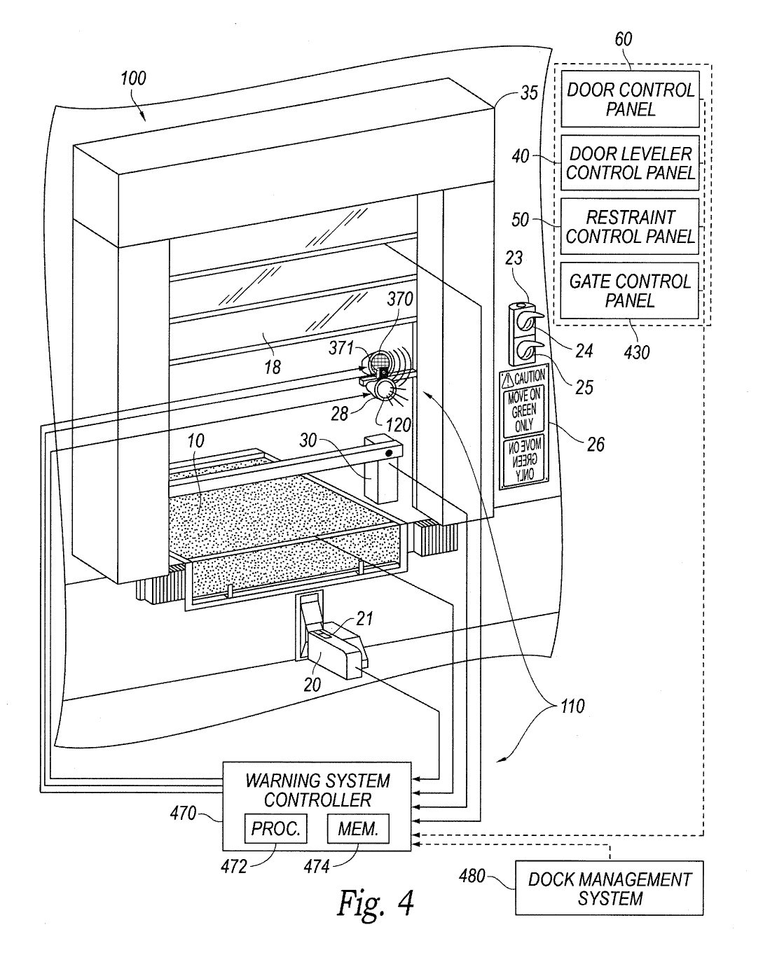

FIG. 4 is an isometric view of the loading dock 100 that schematically illustrates various components and electronic circuitry associated with the lighting system 110 described above. In the illustrated embodiment, the lighting system 110 includes a warning system controller 470 operably coupled to (e.g., electrically connected to) a processor 472 and memory 474. The system controller 470 can include a PLC and/or other suitable processing devices that control operation of the signal light 120 and/or the speaker 370 in accordance with preprogrammed instructions and/or in response to inputs from one or more pieces of dock equipment. For example, in the illustrated embodiment the controller 470 can receive input signals from the door control panel 60, the dock leveler control panel 40, the restraint control panel 50, a gate control panel 430, etc. The signals can include control inputs (e.g., On, Off, etc.) received from the dock operator when operating one or more pieces of the corresponding dock equipment. In addition, the controller 470 can also receive status inputs from the dock equipment including, for example, the vehicle restraint 20, the door 18, the barrier gate 30, the dock leveler 10, etc. In some embodiments, the controller 470 can receive inputs (e.g., control and/or status inputs) from a building or dock management system 480, and/or transmit status and other types of information to a building or dock management system 480. Such dock management systems can include, for example, one or more of the dock management or monitoring systems disclosed in U.S. Pat. Nos. 5,831,540 and 7,119,673, both of which are incorporated herein in their entirety by reference. Other examples of such systems can include the 4Sight Management System offered by 4Front Engineered Solutions, Inc. of 1612 Hutton Drive, Suite 140 Carrollton, Tex. 75006.

In one embodiment, the controller 470 can be positioned in a box associated with one or more of the control panels. In another embodiment, the controller 470 can be incorporated into the dock light housing 324 (FIG. 3B), and the light housing can include one or more terminals for receiving input signals from the various pieces of dock equipment and control panels described above.

Upon receiving information indicating a change in equipment status, the controller 470 transmits corresponding signals to the signal light 120 and/or the speaker 370. For example, when the dock operator presses a button or switch on the restraint control panel 50 to engage the vehicle restraint 20 with a trailer RIG, the control panel 50 transmits a signal to the controller 470 indicating that the vehicle restraint 20 should be in the “engaged” position. Similarly, the vehicle restraint 20 can send a corresponding signal to the controller 470 when the barrier 21 is properly engaged with the vehicle RIG. In the event that the vehicle barrier 21 is prematurely and/or inadvertently disengaged from the vehicle, the restraint 20 can send a corresponding signal to the controller 470 causing the controller 470 to in turn illuminate the colored LED array 328b (FIG. 3B) of the signal light 120. The immediate and conspicuous change in the ambient light color from, for example, white to red permeates the far reaches of the trailer and immediately alerts the operator and other persons working in and around the trailer that the vehicle barrier has disengaged or may disengage and, accordingly, they should stop work and investigate. Simultaneously, the controller 470 can also send activate the speaker 370 to broadcast an audible alarm which the operator can hear even while deep in the trailer.

As described above, in one embodiment the signal light 120 can convey the change in status of the vehicle barrier 20 to the operator by means of a bright red light. In another embodiment, the controller 470 can illuminate an array of blue lights on the signal light 120 to notify the operator of a change in status of a different piece of dock equipment, such as the dock leveler 10. Moreover, the controller 470 can cause the signal light 120 to display yet another color of light, such as amber, in the event that the barrier gate 30 inadvertently closes, the over-head door 18 inadvertently closes, or some other event takes place to change the status of a particular piece of dock equipment that a person working in or around a trailer at the loading dock 100 may wish to know about. Other combinations of light colors, flashing sequences, audible signals, etc. can be used to communicate other types of information.

In other embodiments, the signal light 120 (and/or the audio device 370, 371) can be used to convey other types of information to persons working in and around a shipping vehicle parked at the loading dock 100. For example, the signal light 120 can be configured to project colored light, flashing light, or some other visible signal in case of a fire, a natural disaster (earthquake, tornado, etc.), or some other event. The signal light 120 can also be configured to project a particular type of visible signal if, for example, a dock supervisor or other person wishes to summon the person or persons working inside the vehicle, the person working in the vehicle has a phone call, or a shift has ended. Accordingly, in one embodiment the signal light 120 can be configured to project a first color of light (e.g., blue, amber, etc.) to convey general information, and a second color of light (e.g., flashing red light) to signal persons to get out of the vehicle.

The signal light 120 can also be used as a tool to communicate to persons working both in and out of the vehicle how long a particular loading or unloading process is taking. For example, if a particular unloading process has taken longer than an allotted amount of time (e.g., 1 hour), then the signal light 20 can change to a first color to so indicate. If the process continues beyond a second amount of time (e.g. 2 hours), then the signal light 120 can change to a second color to so indicate. Moreover, in any of the embodiments described herein an additional signal light (e.g., a signal light at least generally similar to the signal light 120) can be positioned proximate the signal light 120, but rather than facing into the shipping vehicle the additional light can face away from the vehicle (e.g., into the building 101). In the foregoing manner, persons positioned outside the vehicle (e.g. a dock supervisor) in the vicinity of the loading dock 100 can immediately ascertain various types of information relating to the loading/unloading process, such as elapsed time.

In some embodiments, the signal light 120 (and/or the audio device 370/371) can display or project the various signals described above in response to inputs received from the dock management system 480. For example, in one embodiment the dock management system 480 can transmit an input signal to the signal light 120 causing the signal light 120 to project an appropriate visible signal when an unloading process has taken longer than an allotted time. The dock management system 480 can generate the input signal automatically in response to an elapsed time clock, or in response to, for example, manual input from a dock supervisor.

The foregoing embodiments described above illustrate only some of the ways that the colored lights of the signal light 120 can be utilized to warn and/or communicate equipment status information to the dock operator or personnel working within a truck or other transport vehicle. Accordingly, in other embodiments, different lights and/or different combinations of colors and/or audible signals can be used to communicate this information without departing from the spirit or scope of the present disclosure.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A loading dock having an opening in a building, the loading dock comprising:
a vehicle restraint positioned proximate the opening in the building, wherein the vehicle restraint is movable between an engaged position in which the vehicle restraint holds a shipping vehicle in front of the opening and a released position in which the vehicle restraint allows the shipping vehicle to move away from the opening;
a dock leveler positioned in the building adjacent to the opening, wherein the dock leveler is movable between a stored position and an extended position in which the dock leveler provides a ramp between the building and an interior portion of the shipping vehicle; and
a lighting system positioned proximate the opening and operably connected to at least one of the vehicle restraint and the dock leveler, wherein the lighting system is configured to illuminate the interior portion of the shipping vehicle when the vehicle restraint is in the engaged position and the dock leveler is in the extended position, and wherein the lighting system is further configured to project a visible signal into the interior portion of the shipping vehicle in response to movement of at least one of the vehicle restraint away from the engaged position and the dock leveler away from the extended position.

2. The loading dock of claim 1 wherein the visible signal includes colored light.

3. The loading dock of claim 1 wherein the visible signal includes flashing light.

4. The loading dock of claim 1 wherein the lighting system includes a first light source and a second light source, wherein the first light source is configured to illuminate the interior portion of the shipping vehicle, and wherein the second light source is configured to project the visible signal into the interior portion.

5. The loading dock of claim 1 wherein the lighting system includes first and second light sources positioned in a housing, wherein the first light source is configured to illuminate the interior portion of the shipping vehicle with light of a first color, and wherein the second light source is configured to project the visible signal into the interior portion with light of a second color.

6. The loading dock of claim 1 wherein the lighting system includes first and second light sources positioned in a housing, wherein the housing is mounted to a distal end of an articulating arm supported by the building proximate the door opening, and wherein the first light source is configured to project white light or at least near white light into the interior portion of the shipping vehicle to illuminate the interior portion, and wherein the second light source is configured to project colored light into the interior portion as the visible signal.

7. The loading dock of claim 1 wherein the lighting system is configured to project a first visible signal in response to movement of the vehicle restraint away from the engaged position, and wherein the lighting system is further configured to project a second visible signal, different than the first visible signal, in response to movement of the dock leveler away from the extended position.

8. The loading dock of claim 1 wherein the lighting system is configured to project a first visible signal in response to movement of the vehicle restraint away from the engaged position, wherein the lighting system is further configured to project a second visible signal in response to movement of the dock leveler away from the extended position, and wherein the first visible signal includes a first color light and the second visible signal includes a second color light, different than the first color.

9. The loading dock of claim 1, further comprising a barrier gate movable between a closed position in which the barrier gate blocks the opening in the building and an open position in which the barrier gate is moved away from the opening, wherein the lighting system is configured to project the visible signal in response to movement of the vehicle restraint away from the engaged position, wherein the lighting system is configured to project the visible signal in response to movement of the dock leveler away from the extended position, and wherein the lighting system is further configured to project the visible signal in response to movement of the barrier gate away from the open position.

10. The loading dock of claim 1, further comprising an audible alarm positioned proximate the opening, wherein the audible alarm is configured to project an audible signal into the interior portion of the shipping vehicle in conjunction with the visible signal.

11. A loading dock comprising:
an opening in a building configured to abut an open end of a shipping vehicle and provide access to an interior portion of the shipping vehicle; and
a lighting system positioned proximate the opening in the building, wherein the lighting system is configured to direct a visible signal into the interior portion of the shipping vehicle in response to a change in status of one or more pieces of loading dock equipment operably associated with the opening in the building.

12. The loading dock of claim 11 wherein the lighting system includes:
means for providing the visible signal with a first type of light; and
means for illuminating the interior portion of the shipping vehicle with a second type of light.

13. The loading dock of claim 11 wherein the lighting system includes:
means for providing the visible signal with a first color of light; and
means for illuminating the interior portion of the shipping vehicle with a second color of light.

14. The loading dock of claim 11 wherein the one or more pieces of loading dock equipment includes one or more of a vehicle restraint, a dock leveler, a barrier gate, and an overhead door.

15. The loading dock of claim 11, further comprising an audio device positioned proximate the opening in the building and operably connected to the lighting system, wherein the audio device is configured to direct an audible signal into the interior portion of the shipping vehicle in response to a change in status of the one or more pieces of loading dock equipment.

16. A lighting system for use at a loading dock, the loading dock including an opening in a building configured to receive an open end of a shipping vehicle and provide access to an interior portion of the shipping vehicle, the lighting system comprising:
at least one light source, wherein the at least one light source is configured to illuminate an interior portion of the shipping vehicle under a first operating condition, and wherein the at least one light source is further configured to project a visible signal into the interior portion of the shipping vehicle under a second operating condition.

17. The lighting system of claim 16 wherein the visible signal includes flashing light.

18. The lighting system of claim 16 wherein the at least one light source includes a first light source, wherein the first light source provides continuous light to illuminate the interior portion of the shipping vehicle under the first operating condition, and wherein the first light source provides flashing light to project the visible signal into the interior portion of the shipping vehicle under the second operating condition.

19. The lighting system of claim 16 wherein the at least one light source illuminates an interior portion of the shipping vehicle with white or near white light, and wherein the at least one light source projects the visible signal into the interior portion of the shipping vehicle by adding colored light to the white or near white light.

20. The lighting system of claim 16, further comprising an audio device operably coupled to the light source, wherein the audio device is configured to project an audio signal into the interior portion of the shipping vehicle in conjunction with the visible signal.

21. The lighting system of claim 16 wherein the at least one light source is configured to be operably connected to one or more pieces of loading dock equipment, and wherein the at least one light source is further configured to project the visible signal into the interior portion of the shipping vehicle in response to a change in operating status of the one or more pieces of loading dock equipment.

22. The lighting system of claim 16 wherein the at least one light source is configured to be operably connected to a dock management system, and wherein the at least one light source is further configured to project the visible signal into the interior portion of the shipping vehicle in response to a signal from the dock management system.

23. The lighting system of claim 16 wherein the at least one light source is configured to be operably connected to one or more pieces of loading dock equipment, wherein the at least one light source is further configured to project the visible signal into the interior portion of the shipping vehicle in response to a change in operating status of the one or more pieces of loading dock equipment, and wherein the visible signal includes colored light.

24. The lighting system of claim 16 wherein the loading dock further includes a vehicle restraint and a dock leveler positioned proximate the opening in the building, and wherein the lighting system further comprises:
a controller operably connected to the at least one light source, wherein the controller is configured to receive input signals from at least one of the vehicle restraint and the dock leveler in response to a change in position of at least one of the vehicle restraint and the dock leveler, wherein the controller is further configured to transmit corresponding control signals to the at least one light source in response to receiving the input signals, and wherein the control signals cause the light source to project the visible signal into the interior portion of the vehicle.

25. The lighting system of claim 16 wherein the at least one light source includes:
a first array of LEDs configured to illuminate the interior portion of the shipping vehicle under the first operating condition, wherein the first array emits a first color of light; and
a second array of LEDs configured to project the visible signal into the interior portion of the shipping vehicle under the second operating condition, wherein the second array emits a second color of light, different than the first color of light.

26. A method for operating a loading dock, the method comprising:
parking a shipping vehicle in front of an opening in a building;
directing light into the interior portion of the vehicle to illuminate the interior portion and facilitate loading/unloading of cargo during normal loading dock operating conditions; and
directing a visible signal into the interior portion of the shipping vehicle in response to a change in the loading dock operating conditions.

27. The method of claim 26, further comprising:
engaging the shipping vehicle with a vehicle restraint to prevent the vehicle from moving substantially away from the opening; and
extending a dock leveler from the building to the interior portion of the shipping vehicle through the opening in the building, wherein directing a visible signal into the interior portion of the shipping vehicle in response to a change in the loading dock operating conditions includes directing a visible signal in response to a change in operational status of at least one of the vehicle restraint and the dock leveler.

28. The method of claim 26 wherein directing light into the interior portion of the vehicle to illuminate the interior portion includes directing light of a first color, and wherein directing a visible signal into the interior portion of the shipping vehicle includes directing light of a second color, different than the first color.

29. The method of claim 26, further comprising operably positioning a light fixture proximate the opening in the building, wherein directing light into the interior portion of the vehicle to illuminate the interior portion includes directing a first type of light from the light fixture, and wherein directing a visible signal into the interior portion of the shipping vehicle includes directing a second type of light, different than the first type of light, from the light fixture.

30. A loading dock comprising:
an opening in a building configured to abut an open end of a shipping vehicle and provide access to an interior portion of the shipping vehicle; and
a lighting system positioned proximate the opening in the building, wherein the lighting system is configured to direct a visible signal into the interior portion of the shipping vehicle in response to an input signal from a dock management system.

31. The loading dock of claim 30 wherein the lighting system includes:
means for providing the visible signal with a first type of light; and
means for illuminating the interior portion of the shipping vehicle with a second type of light.

32. The loading dock of claim 30, wherein the dock management system is configured to transmit the input signal to the lighting system when a vehicle loading or loading process has exceeded an allotted period of time.
